(19) United States
(12) Patent Application Publication
(10) Pub. No.: US 2002/0103719 A1
(43) Pub. Date: Aug. 1, 2002

(54) Color change method and product

(76) Inventor: Jennifer L. Beedy, LaGrange, GA (US)

Correspondence Address: Milliken & Company, P.O. Box 1927, Spartanburg, SC, 29304, US

(21) Appl. No.: 10/060,786

(22) Filed: Jan. 30, 2002

Related U.S. Application Data
(60) Provisional application No. 60/265,389, filed on Jan. 30, 2001.

(51) Int. Cl. G06F 17/60

(52) U.S. Cl. 705/26

(57) ABSTRACT

A color and/or base change process allows the consumer (customer, dealer, distributor) to communicate directly with a designer or other staff and change any of the existing designs to another base fabric or change colors within a design using any standard sample or color blanket. There are no complex diagrams, cumbersome pom boxes, paperwork for the consumer, or large order minimums—as in the past. Once the change is made, the consumer will preferably receive an e-mail image or laser print image of the changed product within 24 hours, a 2′×3′ sample will be sent within 7 days, and the final product is also available within 7 days. This is a complete custom job within a 2 week time period.

### CROSS-REFERENCE TO RELATED APPLICATIONS

This application claims priority to and benefit of prior filed U.S. Provisional Patent Application Serial No. 60/265,389, filed Jan. 30, 2001, hereby incorporated by reference herein.

### FIELD OF THE INVENTION

This invention relates to a method or process for ordering and/or changing a product and the product produced by the process. More particularly, the present invention is directed to a system, process or method which allows a customer, dealer, distributor and/or the like to change the base, base color, background color, accent colors, and/or pattern or design colors of existing products and thereby provide for variations in product colors and/or bases on demand and provide for custom, special, or one of a kind products.

### BACKGROUND OF THE INVENTION

Conventional floor covering product ordering systems, processes, methods, and the like usually provide or allow for a customer, dealer, distributor, or the like to order products from a set product offering (product type, design, color, size, etc.). If the customer asks for the product with the same design or pattern, but in a different color, the dealer, distributor, or product company usually says “NO!”. They would not make or sell the floor covering product (carpet tile, broadloom, area rug, floor mat, or the like) other than as provided in the product offering or line.

Hence, there is a need for an improved color and/or base change method and/or product.

### SUMMARY OF THE INVENTION

In accordance with the present invention, a customer, dealer, retailer, distributor, and/or the like is able to change the base, base color, background color, accent colors, and/or pattern or design colors of existing products and thereby provide for variations in product bases and/or colors on demand and provide for custom, special, or one of a kind products.

In one embodiment, the present process allows the consumer (customer, retailer, dealer, distributor) to communicate directly with the product company and change any of the existing designs to another base fabric or change colors within a design using any standard sample or a color blanket. There are no complex diagrams, cumbersome pom boxes, paperwork for the consumer, or large order minimums—as in the past. Once the change is made, the consumer will preferably receive an e-mail image or laser print image of the changed product within 24 hours, a 2′×3′ sample will be sent within 7 days, and the final product is also available within 7 days. This is a complete custom job within a 2 week time period. This is unprecedented!

In at least one embodiment, the present process allows the consumer (customer, dealer, distributor) to communicate with a designer, dealer, distributor, salesperson, or other staff and change any of the existing product designs to another base fabric and/or change colors within a design using any standard sample or color blanket. Once the change is made, the consumer will preferably receive an e-mail image or laser print image of the changed product, a sample, and the final product.

In accordance with one embodiment, the present invention allows the residential consumer freedom to create their own carpet with the help of a designer, dealer, distributor, salesperson, or the like with less complexity and amazing speed.

The consumer does not have to settle for a standard color selection of a design. The consumer is able to change colors that will suit their needs, match decor, coordinate with furniture, etc.

Customization in the past has been extremely complicated and has had large order minimums, with the present invention these are not an issue.

One object of the invention is to provide a method or process for changing a product and the product produced by the process.

An object of the invention is the provision of a process or method of providing for custom products by allowing the consumer (customer, dealer, retailer, distributor, or the like) to change the floor covering product base, background color, accent colors, pattern colors, and/or the like.

Another object of the present invention is the provision of custom floor covering products which are produced on demand by, for example, jet dyeing of a pattern or design on a white, colored, or multi-colored base or substrate. One of a kind products (carpet, broadloom, area rugs, mats, or the like) can be produced one after another as a particular base is run through the printing or dyeing (preferably digital printing) apparatus. They can be produced nested in broadloom form and then cut apart.

Still another object of the invention is the provision of an automated system for accepting customer changes in bases, background color, accent color, etc. via a website and feeding this information to the computer controlled machine which produces the product.

### BRIEF DESCRIPTION OF THE FIGURES

FIG. 1 is a schematic flow diagram of a system or method in accordance with at least one embodiment of the present invention.

FIG. 2 is a schematic flow diagram of a system or method in accordance with at least one embodiment of the present invention.

FIG. 3 is a color chart illustrating the range of colors which can be selected in accordance with one product (color blanket).

FIG. 4 is an exemplary illustration of an embodiment of an offered floor covering product or pattern.

FIG. 5 is an exemplary representation of the product or pattern of FIG. 4 with the background color changed.

FIG. 6 is an exemplary illustration of the product of FIG. 5 with a different color of the pattern elements (the product or pattern of FIG. 4 with the background, pattern and insert colors changed).

### DETAILED DESCRIPTION OF THE INVENTION

In accordance with the present invention, a customer, dealer, distributor and/or the like is able to change the base, base color, background color, accent colors, and/or pattern or design colors of existing products and thereby provide for variations in product base and/or colors on demand and provide for custom, special, or one of a kind products.

In at least one embodiment, the present process allows the consumer (customer, dealer, retailer, distributor, or the like) to communicate with a designer, dealer, distributor, salesperson, or other staff and change any of the existing product designs to another base fabric and/or change colors within a design using any standard sample or color blanket. Preferably, there are no complex diagrams, cumbersome pom boxes, paperwork for the consumer, or large order minimums. Once the change is made, the consumer will preferably receive an e-mail image or laser print image of the changed product within 24 hours, a 2′×3′ sample will be sent within 7 days, and the final product is also available within 7 days. This is a complete custom job within a 2 week time period. This is amazing!

The present invention allows the consumer freedom to create their own custom floor covering products with the help of a designer, dealer, distributor, salesperson, or the like with less complexity and amazing speed.

In accordance with at least one embodiment, floor covering products are produced on demand by, for example, weaving, tufting, printing, or jet dyeing of a pattern or design on a white, colored, or multi-colored base or substrate.

One of a kind products (carpet, broadloom, area rugs, mats, or the like) can be produced one after another as a particular base is run through the printing or dyeing (preferably digital printing) apparatus. They can be produced nested in broadloom form and then cut apart.

In an accordance with at least one embodiment, a custom product is produced having a change in the base and/or in the color of the base, background, inserts, and/or pattern as compared to the customarily offered product. Preferably, the custom product is at least one of a carpet, carpet tile, broadloom, area rug, floor mat, or the like.

In accordance with another embodiment, a method of customizing floor covering products includes allowing a customer to change the color of at least one of the background, base, accents, pattern, design, or the like. Preferably, the custom product is jet dyed and produced on demand.

In at least one embodiment, the present process allows the consumer (customer, dealer, distributor) to communicate via telephone, mail, courier, email, fax, website, or the like with a designer, dealer, distributor, salesperson, or other staff and change any of the existing product designs to another base fabric and/or change colors within a design using any standard sample colors or color blanket.

The present invention allows the consumer freedom to create their own custom floor covering products with less complexity and amazing speed.

In accordance with at least one embodiment, floor covering products are produced on demand by, for example, weaving, tufting, printing, or jet dyeing of a pattern or design on a white, colored, or multi-colored base or substrate.

In accordance with at least one embodiment, a custom product is produced having a change in the base and/or in the color of the base, background, inserts, and/or pattern as compared to the customarily offered product. Preferably, the custom product is at least one of a carpet, cushion back carpet, carpet tile, cushion back carpet tile, broadloom, area rug, floor mat, or the like.

In accordance with another embodiment, a method of customizing floor covering products includes allowing a customer to change the color of at least one of the background, base, accents, pattern, design, or the like. Preferably, the custom product is jet dyed and produced on demand.

In one exemplary embodiment or example, the present process allows the consumer (customer, dealer, distributor) to communicate directly with a Milliken designer or other Milliken staff (by phone, e-mail, fax, etc.) and change any of Milliken's existing designs to another base fabric and/or change colors within a design using any standard sample or a color blanket. There are no complex diagrams, cumbersome pom boxes, paperwork for the consumer, or large order minimums—as in the past. Once the change is made, the consumer will preferably receive an e-mail image or laser print image of the changed product within 24 hours, a 2′×3′ sample will be sent within 7 days, and the final product (such as carpet, rug, mat, tile, etc.) is also available within 7 days. Such a complete custom job within a 2 week time period is unprecedented!

The present invention allows the residential consumer freedom to create their own carpet with the help of a designer, dealer, distributor, salesperson, or the like with less complexity and amazing speed.

The consumer does not have to settle for a standard color selection of a design, the consumer is able to change colors that will suit their needs.

Customization in the past has been extremely complicated and has had large order minimums, with the present invention these are not an issue.

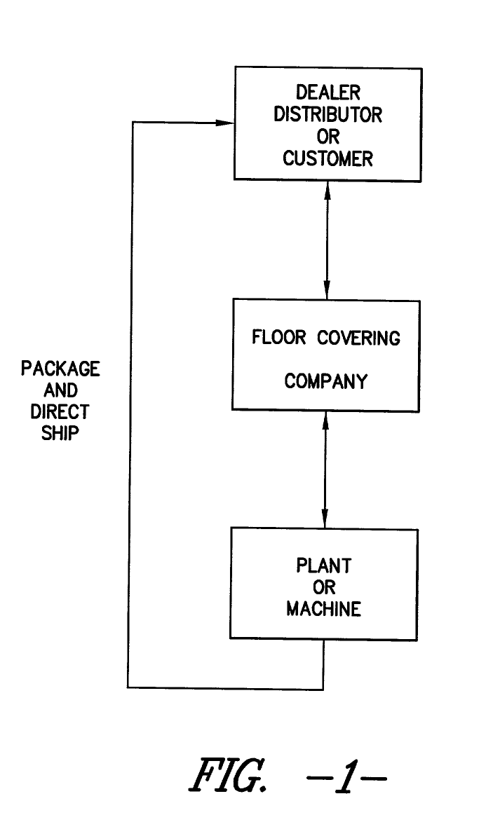

FIG. 1 is a schematic representation of the process or method of providing for custom products by allowing the consumer (customer, dealer, retailer, or distributor) to change the floor covering product base, background color, accent colors, pattern colors, and the like.

For example, a customer goes to a floor covering product dealer or retail outlet, the dealer or retailer shows the customer a product sample (a particular color and design) and a blend blanket (showing a variety of available colors) related to that product. The customer tells the dealer that they want the product with the design in the sample but with a different background color selected from the blend blanket. The dealer calls the product company and orders the custom product (design with new background color) for the customer.

In another example, a distributor looks at a floor covering product offering and a blend blanket (color selection, color palette, color range) for that product offering and orders a quantity of the selected product (broadloom carpet, cushion back broadloom carpet, hardback carpet tile, cushion back carpet tile, rug, mat, runner, and/or the like) in a selected color or color combination from the bland blanket (custom color product).

In still another example, a customer looks at a plurality of samples each with a particular design or pattern (color or colors) on one or more different bases or substrates (such as loop pile, cut loop pile, cut pile, cut and loop pile, textured pile, woven, tufted, bonded, non-woven, needled, flocked, and the like) and looks at a blend blanket (color selection, color range, color palette, etc.) and decides to order one or more samples of custom products (selected design, color or colors, and base). After reviewing the sample or samples, the customer decides to order one or more custom products.

For broadloom tufted carpet, bases may vary in face weight (for example, 24 oz/yd², 32 oz/yd² or 40 oz/yd²). Hence, the customer may select a pattern or design that is customarily offered on the 40 oz/yd² base and ask that it be run on the 32 oz/yd² base.

Another base change would be to go from a white base to a colored base or a multi-colored base (yarn dyed, solution dyed, space dyed).

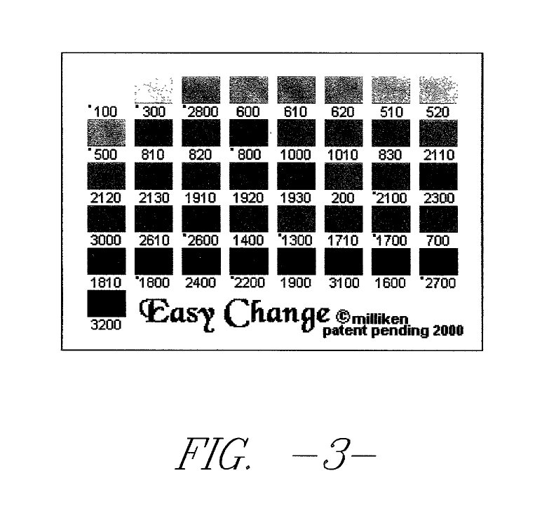

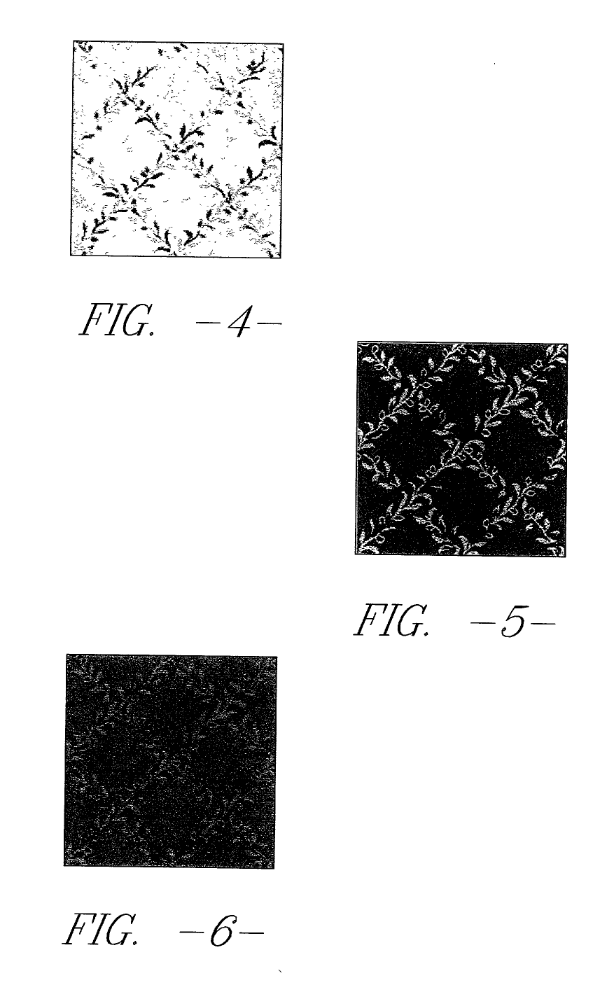

Background color change is illustrated in FIGS. 4 and 5 of the drawings.

Accent color changes (or pattern or design element color changes) are shown in FIGS. 4 and 6 or 5 and 6 of the drawings.

Pattern or design elements may include lines, geometric shapes, logos, text, stems, petals, leaves, fruit, or the like.

Changes in base, background color, accent colors, and/or pattern element colors can drastically affect the overall impression of a product.

Floor covering products which are produced on demand by, for example, jet dyeing of a pattern or design on a white, colored, or multi-colored base or substrate are especially suited to the method of the present invention.

The manufacture of decorative carpets, rugs, mats, carpet tile, and other textile substrates is performed by weaving, tufting or printing processes using highly specialized machines. One such printing machine is an “automated patterning apparatus” that includes a plurality of programmable color dye jets or ink flow valves that are coordinated to receive precise firing instructions in order to render a patterned image upon the substrate. One such machine implemented by Milliken & Company is known as the “Millitron” and comprises an array or matrix of stationary color dye applicators, each of which provides a flow of dye material that may be interrupted at precise times so that the appropriate amount of dye material may be applied to a moving fibrous pile substrate to accurately render a color pattern thereon. Other machines such as direct jet machines have color dye valves that provide for the direct application of color dyes to the fibrous pile material substrate through the use of one or more sets of dye valves that either are stationary or that traverse across the face of the substrate to be patterned.

One of a kind products (carpet, broadloom, area rugs, mats, carpet tile, rugs, rugets, or the like) can be produced one after another as a particular base is run through the printing or dyeing (preferably digital printing) apparatus. In other words, they can be printed or dyed in broadloom form (nested) and then cut apart into separate items.

The present invention also relates to the manufacture of custom carpets, rugs, mats, carpet tiles, or other textile material products, and particularly to a system and methodology that enables users to modify and/or customize a product.

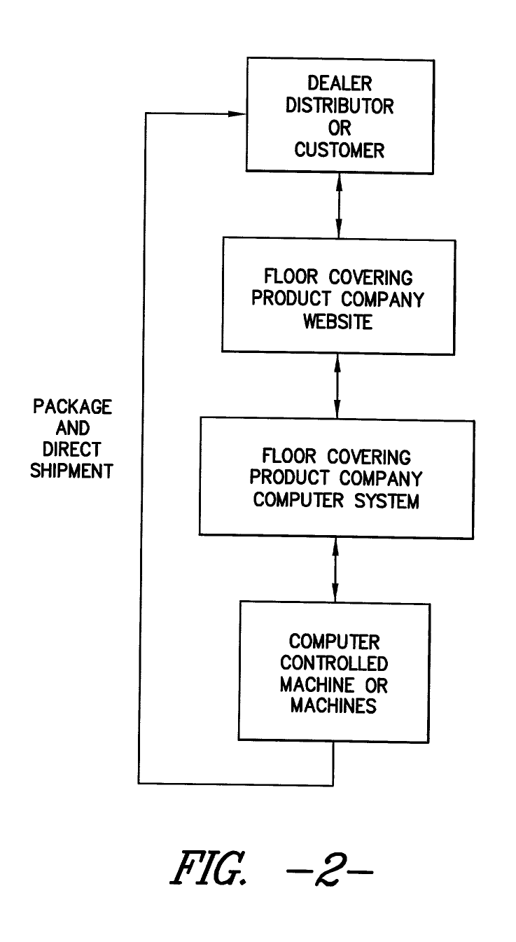

FIG. 2 of the drawings shows an automated system for accepting customer changes in bases, background color, accent color, etc. via a website on the internet or World Wide Web (WWW) or other communications network such as a Local Area Network (LAN) and feeding this information to the computer controlled machine which produces the product.

For example, a customer at a carpet dealership selects a custom color for the background of a particular product (design and base). The dealer gets on-line and makes the order with custom color via the product company website. This custom order information is transmitted to the product company computer system which sends electronic commands to a computer controlled jet dye machine to produce the custom product. The custom product is produced, finished, packaged, and shipped to the dealer or direct shipped to the customer.

FIG. 3 of the drawings shows a color palette or color blanket for a particular product (design, pattern) from which a customer may select different background or accent colors. The color choices are limited by the particular colored yarns, colorway used in the printing or dyeing apparatus for that particular product, base run, etc.

FIG. 2 illustrates an automated system having the advantage of allowing the customer (dealer, retailer, distributor, or customer) to view the product and to view the color blanket and then to order or request the change via the website, the website communicates with the company's computer system, and the company's or another company's machine produces the requested product or sample (if it is not available out of inventory).

The color blanket of FIG. 3 facilitates the Milliken® Easy Change™ process or color change process by representing the available colors (for a particular product, pattern, colorway).

The designer or manufacturer can use the color number adjacent to the color on the color blanket selected by the customer to change the firing instructions in the printing or dyeing machine to change the color of the background, accents, or design elements or can select a different colored base to change the background color. Over printing or dyeing is contemplated in addition to a single pass dye process.

While the invention has been described and disclosed in connection with certain preferred embodiments and procedures, it is by no means intended to limit the invention to such specific embodiments and procedures. Rather it is intended to cover all such alternative embodiments, procedures, and modifications thereto as may fall within the true spirit and scope of the invention. Modifications may be made and other embodiments of the principles of this invention will occur to those skilled in the art to which this invention pertains. Therefore, it is contemplated by the appended claims to cover any such modifications and other embodiments as incorporate the features of this invention within the true spirit and scope thereof.

What is claimed is:

1. A custom product having a change in at least one of the base, the color of the base, the color of the background, the color of the inserts, and the color of the pattern as compared to the customarily offered product.

2. The product of claim 1, wherein the product is at least one of a carpet, carpet tile, broadloom, area rug, floor mat, rug, and ruget.

3. The product of claim 1, wherein the colors are selected from a blend blanket for that product.

4. The product of claim 1, wherein the bases are selected from the group of cut loop pile, cut pile, loop pile, cut and loop pile, textured pile, tufted, bonded, woven, non-woven, needed, and flocked.

5. The product of claim 1, wherein the base and at least one color are changed.

6. A method of customizing floor covering products by allowing at least one of a customer, dealer, retailer, and distributor to change the color of at least one of the background, base, accents, pattern, design, and combinations thereof.

7. The method as recited in claim 6, wherein the product is jet dyed.

8. The method as recited in claim 6, wherein the product is produced on demand.

9. A custom product produced by the method of claim 6.

10. A custom product produced by the method of claim 7.

11. A custom product produced by the method of claim 8.

12. The method as recited in claim 6, wherein the changes are made by communicating the changes to a product company by at least one of telephone, mail, courier, e-mail, fax, website, and combinations thereof.

13. The method as recited in claim 6, wherein the changes are made via a website on the internet.

14. The method as recited in claim 6, wherein the changes are made for a customer by at least one of a designer, dealer, retailer, distributor, and salesperson.

15. The method as recited in claim 6, wherein the product is direct shipped to at least one of the customer, dealer, retailer, and distributor.
